(19) United States
(12) Patent Application Publication
(10) Pub. No.: US 2018/0262225 A1
(43) Pub. Date: Sep. 13, 2018

(54) PROTECTIVE CASE AND ELECTRONIC ASSEMBLY

(71) Applicant: HTC Corporation, Taoyuan City (TW)

(72) Inventors: Hung-Chuan Wen, Taoyuan City (TW); Meng-Sheng Chiang, Taoyuan City (TW)

(73) Assignee: HTC Corporation, Taoyuan City (TW)

(21) Appl. No.: 15/452,751

(22) Filed: Mar. 8, 2017

(51) Int. Cl. H04B 1/3888; G06F 1/16

(52) U.S. Cl. CPC H04B 1/3888; G06F 1/1656

(57) ABSTRACT

A protective case is adapted to protect an electronic device. The protective case includes a frame and a cloth piece. The frame is adapted to frame the electronic device. A periphery of the cloth piece is connected to the frame, wherein a material of the cloth piece is elastic fabric. When the frame frames the electronic device, the cloth piece is elastically stretched according to an external shape of the electronic device. An electronic assembly including the aforementioned protective case and the electronic device is also provided.

### BACKGROUND

### Technical Field

The invention relates to a protective case, and particularly relates to a protective case and an electronic assembly having the same.

### Related Art

Tablet devices such as smart phones and table computers are widely used, and related accessories are accordingly developed quickly. Particularly, accessories such as protective cases, etc. are quickly developed. Such type of the accessories generally covers a periphery and a back part of the tablet device, and exposes components such as a display, a loudspeaker, a microphone, a camera, etc. of the tablet device, so as to guarantee a normal operation of these components.

Current protective cases are generally made of a rigid material such as plastic or metal, etc. If the protective case made of the rigid material such as plastic or metal, etc. is adopted to protect the tablet device, not only a thickness and a weight of the tablet device are increased, sometimes burrs formed on the protective case due to unstableness of manufacturing quality may also cause a damage to the tablet device. Moreover, appearances and touch feelings of most of the rigid material protective cases are similar, and a user cannot experience the ever-changing freshness.

### SUMMARY

The invention is directed to a protective case, which provides good protection quality to an electronic device, presents a fit appearance and provides a user with a comfortable touch feeling.

The invention is directed to an electronic assembly, which presents a fit appearance and provides a user with a comfortable touch feeling.

The invention provides a protective case, which is adapted to protect an electronic device. The protective case includes a frame and a cloth piece. The frame is adapted to frame the electronic device. A periphery of the cloth piece is connected to the frame, wherein a material of the cloth piece is elastic fabric, and when the frame frames the electronic device, the cloth piece is elastically stretched according to an external shape of the electronic device.

The invention provides an electronic assembly including an electronic device and a protective case. The protective case is adapted to protect the electronic device. The protective case includes a frame and a cloth piece. The frame is adapted to frame the electronic device. A periphery of the cloth piece is connected to the frame, wherein a material of the cloth piece is elastic fabric, and when the frame frames the electronic device, the cloth piece is elastically stretched according to an external shape of the electronic device.

According to the above description, in the invention, the cloth piece is elastically stretched according to the appearance of the electronic device, such that the electronic assembly has a neat appearance, and provides a comfortable touch feeling to the user.

In order to make the aforementioned and other features and advantages of the invention comprehensible, several exemplary embodiments accompanied with figures are described in detail below.

### BRIEF DESCRIPTION OF THE DRAWINGS

FIG. 1 is a schematic diagram of a protective case according to an embodiment of the invention.

FIG. 2 is a cross-sectional view of an electronic assembly according to an embodiment of the invention.

FIG. 3 is a cross-sectional view of an electronic assembly according to another embodiment of the invention.

FIG. 4 is a cross-sectional view of an electronic assembly according to still another embodiment of the invention.

FIG. 5 is an exploded view of a protective case according to an embodiment of the invention.

FIG. 6 is a cross-sectional view of an electronic assembly according to still another embodiment of the invention.

FIG. 7 is a cross-sectional view of an electronic assembly according to still another embodiment of the invention.

FIG. 8 is a cross-sectional view of an electronic assembly according to still another embodiment of the invention.

### DESCRIPTION OF EMBODIMENTS

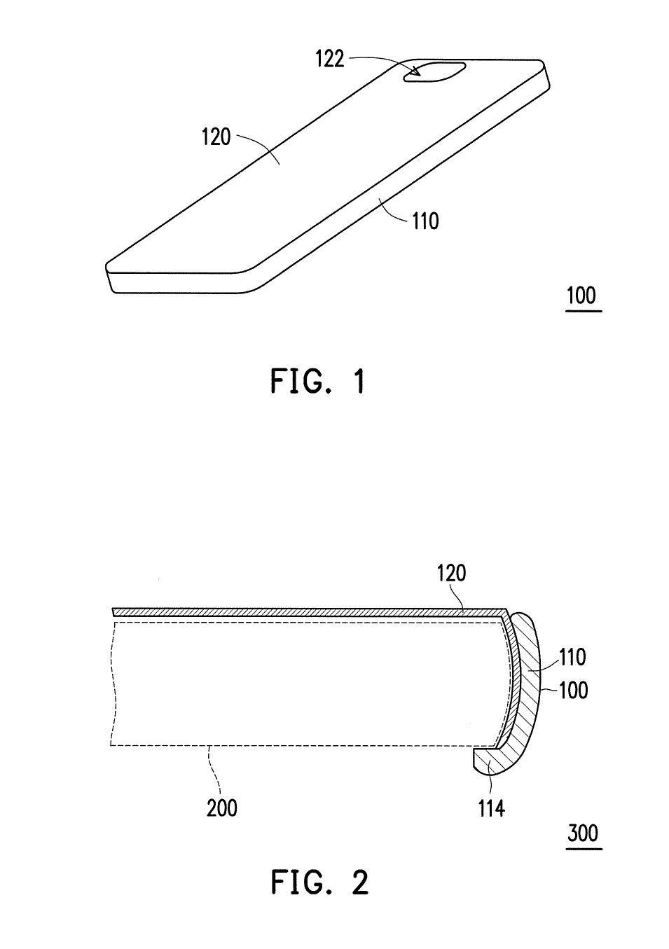

FIG. 1 is a schematic diagram of a protective case according to an embodiment of the invention, and FIG. 2 is a cross-sectional view of an electronic assembly according to an embodiment of the invention. Referring to FIG. 1 and FIG. 2, in the present embodiment, the electronic assembly 300 includes an electronic device 200 and a protective case 100. The electronic device 200 is, for example, a smart phone. However, in other embodiment that is not illustrated, the electronic device 200 may be a tablet personal computer or any type of electronic device having a display. The protective case 100 includes a frame 110 and a cloth piece 120. The frame 110 is used for framing a periphery of the electronic device 200, as shown in FIG. 2.

Referring to FIG. 2, a material of the frame 110 may be a rigid material, for example, plastic or metal, and a material of the cloth piece 120 is elastic fabric, and the cloth piece 120 is manufactured according to a general weaving method or weaved according to a 3D weaving technology. A periphery of the cloth piece 120 is connected to the frame 110 through a hot melting method. In the present embodiment, the periphery of the cloth piece 120 may be melted to connect an inner side or an outer side of the frame 110 through the hot melting method, though the invention is not limited thereto.

Moreover, the cloth piece 120 may have a plurality of different patterns to present different appearances, and the cloth piece 120 can also be made of a cloth material with a special characteristic, for example, anti-mildew, anti-water, anti-fouling, anti-bacterial or noctilucence, etc., such that the protective case 100 has a plurality of different functions.

Referring to FIG. 2, when the frame 110 frames the periphery of the electronic device 200, the elastic cloth piece 120 has a tension concentrated to a center, such that the cloth piece 120 can be elastically stretched according to the external shape of the electronic device 200, and the electronic assembly 300 may present a neat appearance and provide a comfortable touch feeling to the user. On the other hand, the frame 110 has a buckle portion 114 for fixing to the periphery of the electronic device 200, such that the electronic device 200 is not easy to fall out of the protective case 100.

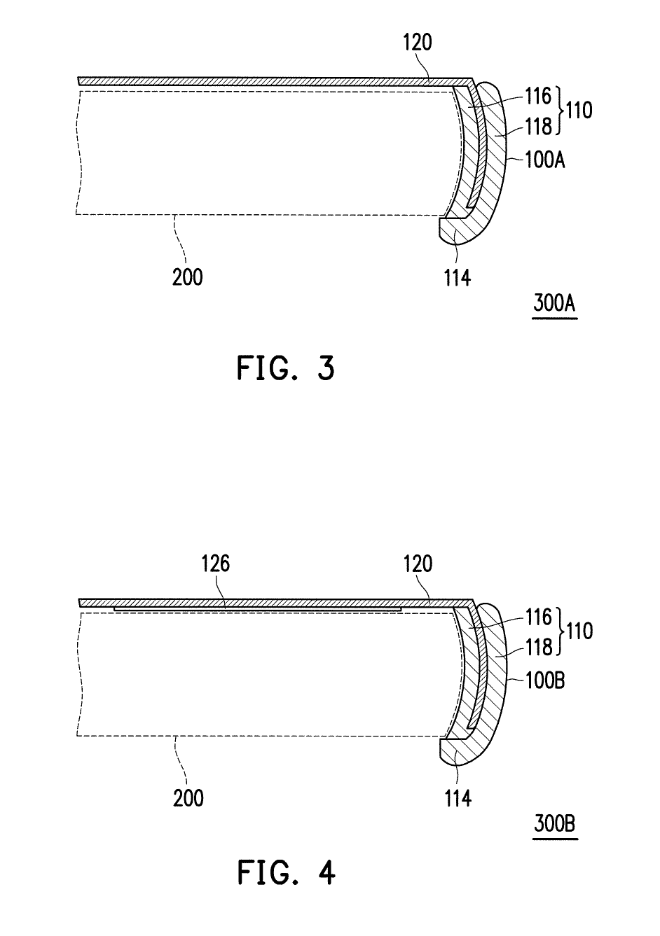

FIG. 3 is a cross-sectional view of an electronic assembly according to another embodiment of the invention. Referring to FIG. 3, the electronic assembly 300A of the present embodiment is similar to the electronic assembly 300 of FIG. 2, and a main difference there between is that the frame 110 of the electronic assembly 300A has an inner frame portion 116 and an outer frame portion 118, and the periphery of the cloth piece 120 is clamped between the inner frame portion 116 and the outer frame portion 118, though the invention is not limited thereto.

FIG. 4 is a cross-sectional view of an electronic assembly according to still another embodiment of the invention. Referring to FIG. 4, the electronic assembly 300B of the present embodiment is similar to the electronic assembly 300 of FIG. 2, and a main difference there between is that the cloth piece 120 of the electronic assembly 300B has a conductive pattern 126. The conductive pattern 126 may be an antenna for improving a signal receiving performance. Alternatively, the conductive pattern 126 may be a sensing electrode to add a sensing function to the electronic assembly 300B, for example, a function of sensing heartbeats. In the present embodiment, the conductive pattern 126 may be configured at an inner side of the cloth piece 120 without influencing the external shape of the electronic assembly 300B. In another embodiment, the conductive pattern 126 may also be configured at the inner side and an outer side of the cloth piece 120 to enhance a performance, though the invention is not limited thereto.

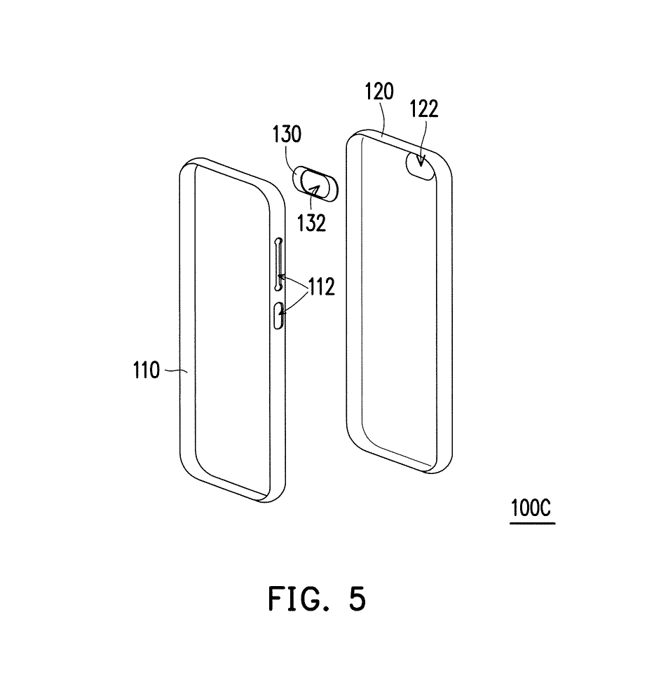

FIG. 5 is an exploded view of a protective case according to an embodiment of the invention. Referring to FIG. 5, the protective case 100C of the present embodiment further includes a physical opening member 130, which is combined with the cloth piece 120 and has a physical opening 132. The cloth piece 120 has a cloth opening 122, and the physical opening 132 is overlapped with the cloth opening 122. The opening structure may be used for exposing an additional functional element of the electronic device 200, for example, a lens, an infrared sensing element, etc. On the other hand, the frame 110 has a plurality of frame openings 112, and positions thereof, for example, correspond to positions of a power button, a volume key, a speaker or an earphone hole, etc.

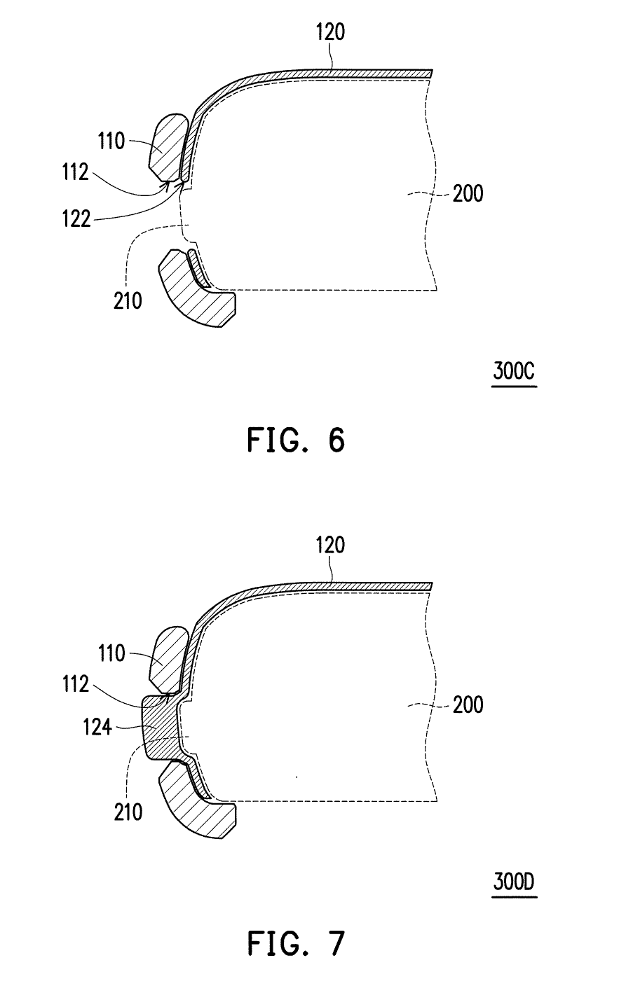

FIG. 6 is a cross-sectional view of an electronic assembly according to still another embodiment of the invention. Referring to FIG. 6, the frame 110 has a frame opening 112 corresponding to a function key 210 of the electronic device 200 of the electronic assembly 300C of the present embodiment, and the cloth piece 120 has a cloth opening 122 and a position thereof corresponds to the frame opening 112, such that the function key 210 of the electronic device 200 is exposed to facilitate the user's finger to directly touch and press the function key 210.

FIG. 7 is a cross-sectional view of an electronic assembly according to still another embodiment of the invention. Referring to FIG. 7, the electronic assembly 300D of the present embodiment is similar to the electronic assembly 300C of FIG. 6, and a main difference there between is that the cloth piece 120 of the electronic assembly 300D has a cloth key 124, and a position thereof corresponds to the frame opening 112 and the function key 210, and the cloth key 124 extends to penetrate through the frame opening 112, such that the user may contact and press the function key 210 by pressing the cloth key 124. The cloth key 124 may be directly formed by the cloth piece 120 through 3D weaving, or another cloth material with a harder fibre may be used to first weave the cloth key 124, and then the cloth key 124 is weaved on the cloth piece 120, such that the user may have a solid touch feeling when pressing the cloth key 124, though the invention is not limited thereto.

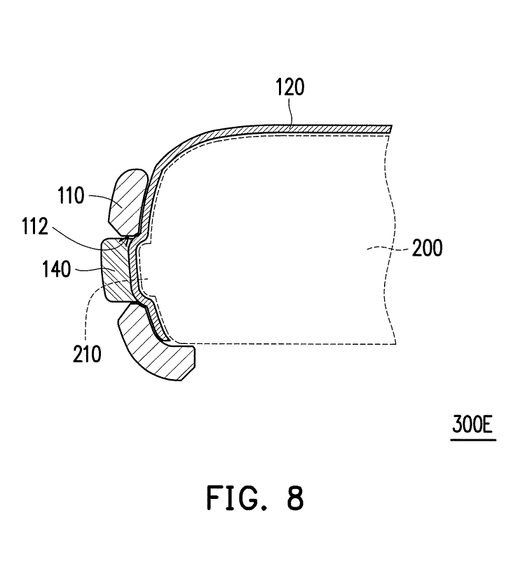

FIG. 8 is a cross-sectional view of an electronic assembly according to still another embodiment of the invention. Referring to FIG. 8, the electronic assembly 300E of the present embodiment is similar to the electronic assembly 300D of FIG. 7, and a main difference there between is that the electronic assembly 300E further includes at least one solid key 140 connected to the cloth piece 120. The solid key 140 may be made of a rigid material such as plastic or metal, such that the user may have the solid touch feeling when pressing the solid key 140, and the solid key 140 and the frame 110 may present a consistent appearance. Therefore, the user may select to use the cloth key 124 or the solid key 140 according to his own preference, though the invention is not limited thereto.

In summary, in the invention, the cloth piece is elastically stretched according to the external shape of the electronic device, such that the electronic assembly has a neat appearance, and provides a comfortable touch feeling to the user.

It will be apparent to those skilled in the art that various modifications and variations may be made to the structure of the invention without departing from the scope or spirit of the invention. In view of the foregoing, it is intended that the invention cover modifications and variations of this invention provided they fall within the scope of the following claims and their equivalents.

1. A protective case, adapted to protect an electronic device, the protective case comprising:
a frame, adapted to frame a periphery of the electronic device; and
a cloth piece, having a periphery connected to the frame, wherein a material of the cloth piece is elastic fabric, and when the frame frames the periphery of the electronic device, the cloth piece is elastically stretched according to an external shape of the electronic device,
wherein the frame has an inner frame portion and an outer frame portion, and the periphery of the cloth piece is clamped between the inner frame portion and the outer frame portion.

2. The protective case as claimed in claim 1, further comprising:
a physical opening member, combined with the cloth piece and having a physical opening, wherein the cloth piece has a cloth opening, and the physical opening is overlapped with the cloth opening.

3. The protective case as claimed in claim 1, wherein a material of the frame is plastic or metal.

4. The protective case as claimed in claim 1, wherein the periphery of the cloth piece is hot melted to connect the frame.

5. The protective case as claimed in claim 1, wherein the frame has a frame opening, and a position thereof corresponds to at least one function key of the electronic device.

6. The protective case as claimed in claim 5, wherein the cloth piece has a cloth opening, and a position thereof corresponds to the frame opening.

7. The protective case as claimed in claim 5, wherein the cloth piece has a cloth key, and a position thereof corresponds to the frame opening, and the cloth piece extends to penetrate through the frame opening.

8. The protective case as claimed in claim 5, further comprising:
at least one solid key, connected to the cloth piece, a position of the solid key corresponding to the frame opening, and the solid key extending to penetrate through the frame opening.

9. The protective case as claimed in claim 1, wherein the cloth piece has a conductive pattern.

10. (canceled)

11. An electronic assembly, comprising:
an electronic device; and
a protective case, adapted to protect the electronic device, and comprising:
a frame, adapted to frame a periphery of the electronic device; and
a cloth piece, having a periphery connected to the frame, wherein a material of the cloth piece is elastic fabric, and when the frame frames the periphery of the electronic device, the cloth piece is elastically stretched according to an external shape of the electronic device,
wherein the frame has an inner frame portion and an outer frame portion, and the periphery of the cloth piece is clamped between the inner frame portion and the outer frame portion.

12. The electronic assembly as claimed in claim 11, further comprising:
a physical opening member, combined with the cloth piece and having a physical opening, wherein the cloth piece has a cloth opening, and the physical opening is overlapped with the cloth opening.

13. The electronic assembly as claimed in claim 11, wherein a material of the frame is plastic or metal.

14. The electronic assembly as claimed in claim 11, wherein the periphery of the cloth piece is hot melted to connect the frame.

15. The electronic assembly as claimed in claim 11, wherein the frame has a frame opening, and a position thereof corresponds to at least one function key of the electronic device.

16. The electronic assembly as claimed in claim 15, wherein the cloth piece has a cloth opening, and a position thereof corresponds to the frame opening.

17. The electronic assembly as claimed in claim 15, wherein the cloth piece has a cloth key, and a position thereof corresponds to the frame opening, and the cloth piece extends to penetrate through the frame opening.

18. The electronic assembly as claimed in claim 15, further comprising:
at least one solid key, connected to the cloth piece, a position of the solid key corresponding to the frame opening, and the solid key extending to penetrate through the frame opening.

19. The electronic assembly as claimed in claim 11, wherein the cloth piece has a conductive pattern.

20. (canceled)
